(19) United States
(12) Patent Application Publication
(10) Pub. No.: US 2009/0033163 A1
(43) Pub. Date: Feb. 5, 2009

(54) MOTOR CASE

(75) Inventor: Chuping LU, Zhongshan (CN)

Correspondence Address: MATTHIAS SCHOLL, 14781 MEMORIAL DRIVE, SUITE 1319, HOUSTON, TX, 77079, US

(73) Assignee: ZHONGSHAN BROAD-OCEAN MOTOR CO., LTD, Zhongshan (CN)

(21) Appl. No.: 12/141,258

(22) Filed: Jun. 18, 2008

(30) Foreign Application Priority Data
Jul. 31, 2007 (CN) 200720055139.1

(51) Int. Cl. H02K 5/04

(52) U.S. Cl. 310/89

(57) ABSTRACT

Provided is a motor case, comprising a body, a pair of endshields disposed on both ends of the body, a cavity formed inside the body, and a pair of flangings extending from the center of the endshields; wherein the flangings extend into the cavity to form a bearing house with two opening ends; and a space is formed between the cavity and the bearing house. The invention has small distance between bearings so as to reduce vibration and noise of a motor, and features a small radial size and volume so as to make the motor case compact and simple.

### CROSS-REFERENCE TO RELATED APPLICATIONS

This application claims priority benefits to Chinese Patent Application No. 200720055139.1 filed on Jul. 31, 2007. The contents of all of the aforementioned specifications are incorporated herein by reference.

### BACKGROUND OF THE INVENTION

1. Field of the Invention

The invention relates to a case structure, and particularly to a motor case.

2. Description of the Related Art

Nowadays, motors are widely used in electronic appliances such as air conditioners, fans, air purifying machines and so on.

FIG. 1 is a motor case in the prior art, a protrusion B is disposed outside a bearing house A. A problem with the motor case is that the protrusion B takes up certain space of a cavity C, which makes it impossible for windings on both sides of a stator to be received outside of the bearing house A, and causes an axial size and a radial size of the motor case to be too large. Moreover, structure of the motor case is incompact and complex, which costs more materials and money.

### SUMMARY OF THE INVENTION

In view of the above-described problems, it is one objective of the invention to provide a motor case that has small distance between bearings so as to reduce vibration and noise of a motor, and features a small radial size and volume so as to make the motor case compact and simple.

To achieve the above objectives, in accordance with one embodiment of the invention, provided is a motor case, comprising a body, a pair of endshields disposed on both ends of the body, a cavity formed inside the body, and a pair of flangings extending from the center of the endshields; wherein the flangings extend into the cavity to form a bearing house with two opening ends; and a space is formed between the cavity and the bearing house.

In certain embodiments of the present invention, one opening end of the bearing house abuts against a pair of stopping plates.

In certain embodiments of the present invention, the stopping plate is disposed on the endshield in a matter of buckling, rivet or welding.

In certain embodiments of the present invention, a hole is disposed at the center of one of the stopping plates.

In certain embodiments of the present invention, a sheet is connected between the endshield and the flanging.

In certain embodiments of the present invention, the sheet is flat-shaped.

In certain embodiments of the present invention, an angle between the sheet and the flanging is rectangular.

In certain embodiments of the present invention, the body comprises a pair of cylinders.

In certain embodiments of the present invention, the endshield is disposed at the end of the cylinder.

In certain embodiments of the present invention, the endshield and the cylinder are integrally formed.

In certain embodiments of the present invention, an assembling surface is disposed at an opening end of the cylinder.

In certain embodiments of the present invention, the cylinders are connected together via the assembling surface.

In certain embodiments of the present invention, the body comprises a cylinder.

In certain embodiments of the present invention, the endshields are disposed on both ends of the cylinder.

In certain embodiments of the present invention, a bolt is disposed on the endshield, and operates to fix the motor.

Advantages of the invention comprise:
1) small distance between bearings can effectively reduce vibration and noise of the motor;
2) space between the bearing house and the cavity can receive wind wheels of a rotor and windings of a stator, which makes a radial size and volume of the motor case small and structure of the motor case compact and simple, and thus saves materials and reduces cost.
3) the stopping plate effectively prevents dust from entering the bearing house; and
4) the flat-shaped sheet allows for full utilization of space outside the bearing house.

### BRIEF DESCRIPTION OF THE DRAWINGS

Detailed description will be given below with reference to accompanying drawings, in which

FIG. 1 is a schematic diagram of a motor case in the prior art;

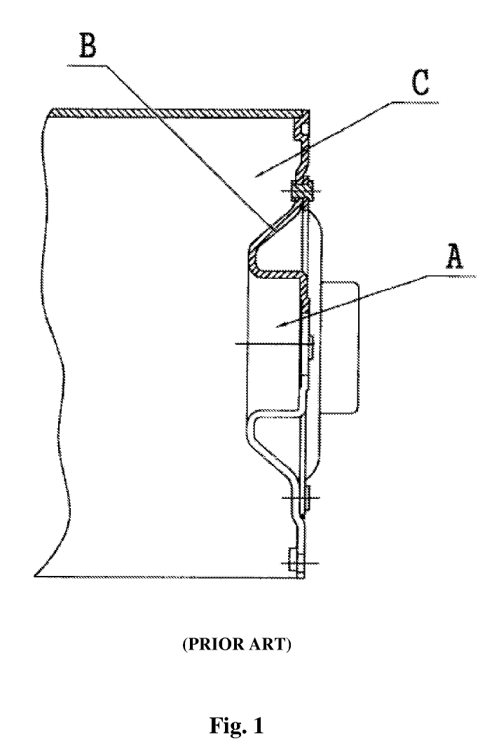

FIG. 2 is a schematic diagram of a motor case of one embodiment of the invention;

FIG. 3 is a schematic diagram of a motor case of another embodiment of the invention;

FIG. 4 is a schematic diagram of a motor having a motor case as shown in FIG. 2; and

FIG. 5 is a schematic diagram of a motor having a motor case as shown in FIG. 3.

### DETAILED DESCRIPTION OF THE EMBODIMENTS

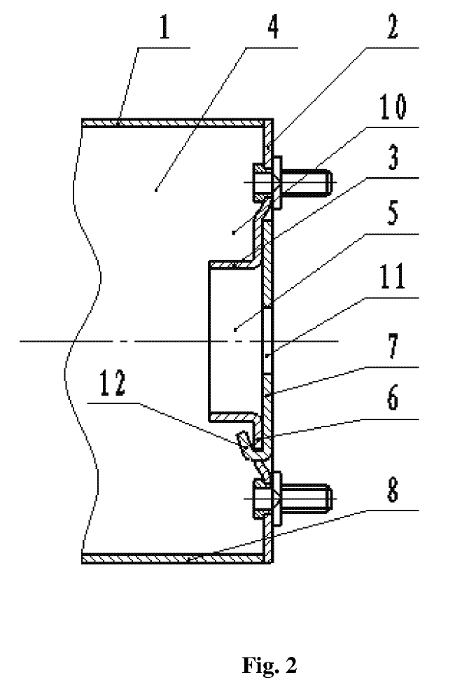

As shown in FIGS. 2-5, a motor case of the invention comprises a body 1, a pair of endshields 2, a cavity 4 and a pair of flangings 3. The endshields 2 are disposed on both ends of the body 1. The cavity 4 is formed inside the body 1. The flangings 3 extend from the center of the endshields 2, and extend into the cavity 4 to form a bearing house 5 with two opening ends.

A space 10 is formed between the cavity 4 and the bearing house 5, and operates to receive end portions of a stator and a rotor of the motor.

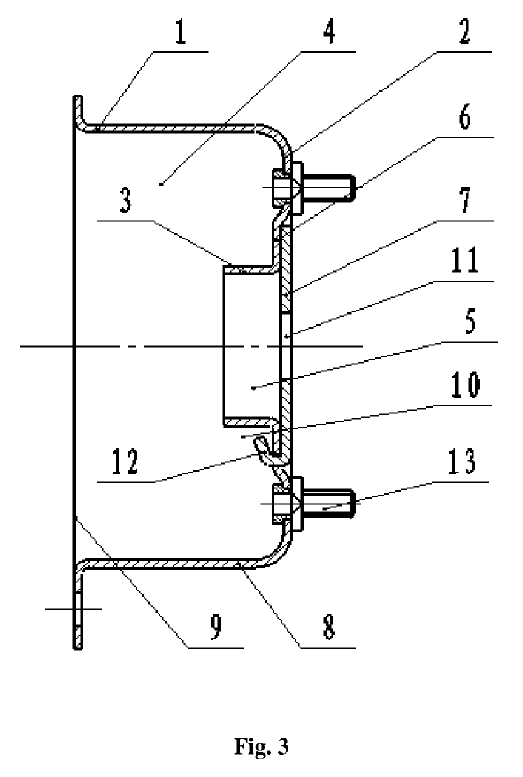

One opening end of the bearing house 5 abuts against a pair of stopping plates 7, and the stopping plate 7 is disposed on the endshield 2 in a matter of buckling, rivet or welding. As shown in FIGS. 2 and 3, a catch 12 is disposed on the edge of the stopping plate 7, and is fixed on the endshield 2.

A hole 11 is disposed at the center of one of the stopping plates 7.

A sheet 6 is connected between the endshield 2 and the flanging 3. In this embodiment, the sheet 6 is flat-shaped, and an angle between the sheet 6 and the flanging 3 is rectangular.

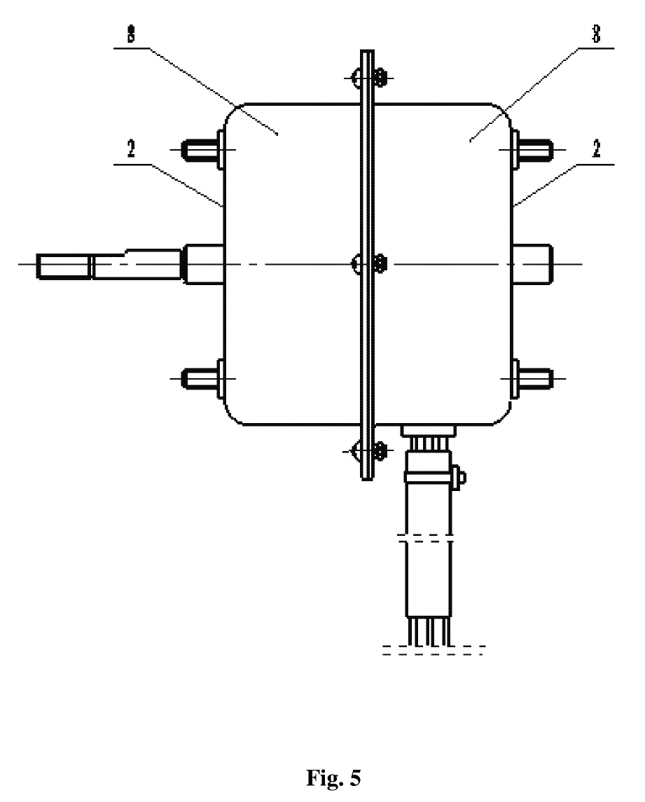

As shown in FIGS. 3 and 5, the body 1 comprises a pair of cylinders 8. The endshield 2 is disposed at the end of the cylinder 8. The endshield 2 and the cylinder 8 are integrally formed. An assembling surface 9 is disposed at an opening end of the cylinder 8, and the cylinders 8 are connected together via the assembling surface 9.

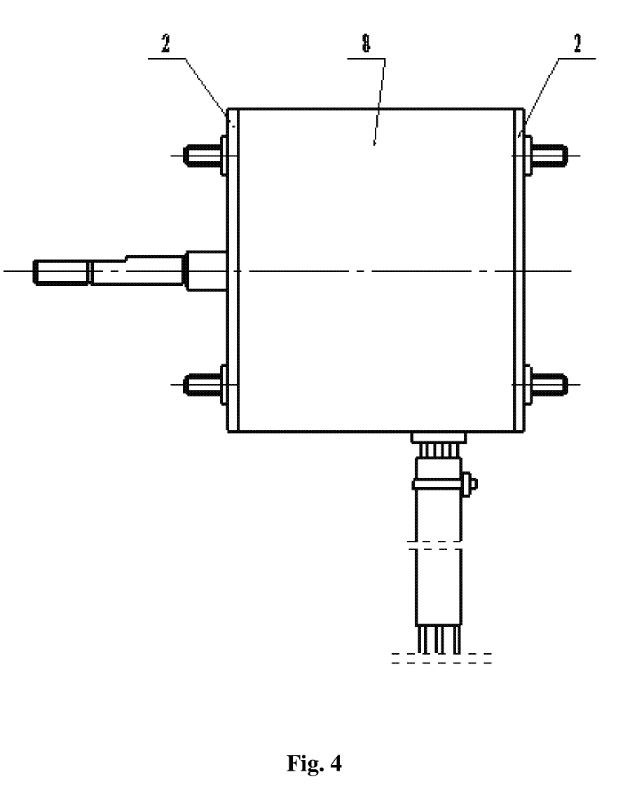

As shown in FIGS. 4 and 6, the body 1 comprises a cylinder 8, and the endshields 2 are disposed on both ends of the cylinder 8. A bolt 13 is disposed on the endshield 2, and operates to fix the motor.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What claimed is:

1. A motor case, comprising
a body (1);
a pair of endshields (2) disposed on both ends of the body (1);
a cavity (4) formed inside said body (1); and
a pair of flangings (3) extending from the center of the endshields (2); wherein
the flangings (3) extend into the cavity (4) to form a bearing house (5) with two opening ends; and
a space (10) is formed between the cavity (4) and the bearing house (5);

2. The motor case of claim 1, wherein one opening end of the bearing house (5) abuts against a pair of stopping plates (7).

3. The motor case of claim 2, wherein the stopping plate (7) is disposed on the endshield (2) in a matter of buckling, rivet or welding.

4. The motor case of claim 3, wherein a hole (11) is disposed at the center of one of the stopping plates (7).

5. The motor case of claim 1, wherein a sheet (6) is connected between the endshield (2) and the flanging (3).

6. The motor case of claim 5, wherein the sheet (6) is flat-shaped.

7. The motor case of claim 6, wherein an angle between the sheet (6) and the flanging (3) is rectangular.

8. The motor case of claim 1, wherein the body (1) comprises a pair of cylinders (8).

9. The motor case of claim 8, wherein the endshield (2) is disposed at the end of the cylinder (8).

10. The motor case of claim 9, wherein the endshield (2) and the cylinder (8) are integrally formed.

11. The motor case of claim 10, wherein an assembling surface (9) is disposed at an opening end of the cylinder (8).

12. The motor case of claim 11, wherein the cylinders (8) are connected together via the assembling surface (9).

13. The motor case of claim 1, wherein the body (1) comprises a cylinder (8).

14. The motor case of claim 13, wherein the endshields (2) are disposed on both ends of the cylinder (8).

15. The motor case of claim 14, wherein a bolt (13) is disposed on said endshield (2), and operates to fix the motor.
